(19) United States
(12) Patent Application Publication
(10) Pub. No.: US 2020/0386843 A1
(43) Pub. Date: Dec. 10, 2020

(54) SYSTEM AND METHOD FOR DETERMINING A LOCATION OF A MOBILE DEVICE BASED ON AUDIO LOCALIZATION TECHNIQUES

(71) Applicant: Certis Cisco Security Pte Ltd, Singapore (SG)

(72) Inventors: Poh Beng TAN, Singapore (SG); Keen Hon WONG, Singapore (SG); Meng Kwang TAN, Singapore (SG)

(73) Assignee: Certis Cisco Security Pte Ltd, Singapore (SG)

(21) Appl. No.: 16/638,682

(22) PCT Filed: Jun. 17, 2018
(86) PCT No.: PCT/SG2018/050283

§ 371 Date: Feb. 12, 2020

(30) Foreign Application Priority Data
Aug. 21, 2017 (SG) 10201706797S

(51) Int. Cl. G01S 1/74; G01S 5/18; H04W 4/029

(52) U.S. Cl. CPC G01S 1/753; G01S 2205/02; H04W 4/029; G01S 5/18

(57) ABSTRACT

This document describes a system and method for determining a location of a mobile device within an enclosed space using audio localization techniques. In particular, the system and method utilizes audio localization techniques to identify the location of a mobile device within a multi-storey multi-room structure or an enclosure with multiple rooms.

### FIELD OF THE INVENTION

This invention relates to a system and method for determining a location of a mobile device within an enclosed space using audio localization techniques. In particular, the system and method utilizes audio localization techniques to identify the location of a mobile device within a multi-storey multi-room structure or an enclosure with multiple rooms.

### SUMMARY OF THE PRIOR ART

The adoption of mobile devices by the masses has increased exponentially over the years. As more and more consumers carry mobile devices around on their daily commute to and during work, it becomes increasingly useful to be able to identify the location of mobile devices, and as a result the location of their users, regardless whether the mobile devices are outdoors or indoors in enclosed spaces.

Navigational aids such as the Assisted Global Positioning System (A-GPS) or Global Positioning System (GPS) are commonly employed by mobile devices to determine the exact location of the devices on Earth. Most mobile devices employ the A-GPS system as this system does not require the use of a dedicated GPS receiver. Instead of using an additional dedicated GPS receiver to receive triangulation signals from GPS satellites, mobile devices that implement the A-GPS system are able to make use of modules that are commonly found in mobile devices to receive triangulation signals from mobile cell towers instead. The triangulation signals from the mobile cell towers are then used to obtain the location of the mobile device.

Regardless whether the GPS or A-GPS system is adopted, these systems only work well when the mobile device is outdoors. In other words, once a mobile device is indoors or within an enclosed structure, the mobile device would not be able to receive triangulation signals from GPS satellites overhead or triangulation signals from mobile cell towers.

It has been proposed that the problem faced by A-GPS systems when indoors may be addressed by introducing multiple mobile cell repeaters within enclosed spaces. This is because when more mobile cell repeaters are installed, the area covered by these mobile cell repeaters increases accordingly thereby allowing the system to identify the location of mobile users within a large enclosed space such as a multi-storey building. Ideally, each room or each unique enclosed space within a larger enclosed space, e.g. a building, should have its own mobile cell repeater. However, in reality, such a proposition is impractical. The aim of an indoor mobile cell repeater is to cater to the transmission of data from mobile devices, when these devices are indoors, to external mobile cell towers. While an enclosed space may include a number of multiple mobile cell repeaters, it becomes cost prohibitive to provide mobile cell repeaters in each and every room in a building. Typically, the number of mobile cell repeaters installed within an enclosed space is dependent on the anticipated number of cell users in that space. Hence, the number of mobile cell repeaters installed in warehouses or large storage sites would be relatively low as there would not be many mobile phone users in these areas. As a result, A-GPS systems would not work well in such environments as it would not be able to identify the room, level or exact location of the mobile device in a multi-story building.

In view of the issues faced by existing A-GPS and GPS systems when indoors, audio based positioning systems have been proposed as an alternative indoor navigational aid. Such systems were chosen because audio systems are commonly found indoors, in buildings and/or in enclosed spaces. Examples of audio systems that may be commonly found in most buildings are public announcement systems and/or in-store audio entertainment systems. When existing audio based positioning systems are successfully enabled in an enclosed space and in an application located within a subject mobile device, this allows users of the mobile device to utilize indoor navigation aids. These indoor navigation aids may then be presented to the user in the form of interactive maps or directions shown through the application installed in the mobile device.

Although audio based positioning systems appear to provide a solution to problems faced by A-GPS and GPS systems when these traditional systems are employed indoors, many challenges remain in the rolling out of practical solutions of these audio based positioning systems. For example, in order to utilize existing audio systems, complex components will need to be integrated into these existing audio systems in order for audio based positioning to be carried out. This is far from ideal as it increases the overall cost of the system. Further, such systems are difficult to maintain, especially if the audio systems are used at buildings that are located at rural areas.

In addition to cost limitations, another challenge faced by audio based positioning systems is the degradation of the transmitted and subsequently received audio signals due to echoes or signal reverberations/attenuations from inanimate objects in the enclosed space. The audio signal may also be degraded further due to interference of the audio signal by other audio sources, such as ambient noise or other external noise generators, which are located in the vicinity of the receiver. The degradation and/or interference of the audio signal lowers the accuracy of the system as audio based positioning systems usually calculate the location of the mobile device based on the received strength of the audio signal. As a result, an audio signal that has been deformed, corrupted or altered due to signal distortion or interference would produce inaccurate results.

Those skilled in the art have tried to address the issue of signal degradation due to the presence of ambient noise or external noise sources by simply increasing the signal strength of the audio signal that's being transmitted so that the transmitted audio signal is stronger than the ambient noise. However, the strength of the audio signal may only be increased to a certain level as once the transmitted signal becomes too loud, it will affect most individuals in the vicinity of the transmitter/receiver. In order to prevent signal interference, it has been proposed that only highly linear audio amplifiers be used to drive the audio transmitters. By doing so, this reduces the formation of spurious frequency signals which may affect the quality of the signal received at the receiver. This approach is not feasible on a large scale as highly linear audio amplifiers are costly and consumes a lot of power. As such, it would be impractical for such amplifiers to be widely deployed in large warehouses or buildings.

For the above reasons, those skilled in the art are constantly striving to come up with a system and method for determining a location of a mobile device within an enclosed space using audio localization techniques that is robust and able to adapt to the presence of ambient noise, signal degradation and/or non-linear signal interference.

### SUMMARY OF THE INVENTION

Systems and methods for identifying a location of a mobile device are proposed, and these systems and methods are set out below in accordance with embodiments of the invention.

A first improvement proposed by embodiments of systems and methods in accordance with the invention is that the location of a mobile device within an enclosed area may be easily identified. To do so, each unique location within the enclosed area only needs to be provided with at least one ultrasonic frequency transmitter that is configured to transmit audio signals that are above the standard audible range of frequencies. An audio receiver in a standard mobile device is then utilized to capture the ambient audio signal before the captured signal is processed to identify the location of the mobile device.

A second improvement proposed by embodiments of systems and methods in accordance with the invention is that as the ultrasonic frequency transmitters are transmitting audio signals beyond the audible frequency range of humans, the transmitted audio signals will not affect the performance of people within range of the audio transmitter.

A third improvement proposed by embodiments or systems and methods in accordance with the invention is that the invention does not need to address the issue of ambient noise in a room as the invention in fact utilizes the room's ambient noise in the identification of the location of the mobile devices. As such, in contrast with existing methods, the ambient noise in the room becomes a useful asset to the invention.

The above improvements are provided by embodiments in accordance with the invention operating in the following manner.

According to a first aspect of the invention, a method for identifying a location of a mobile device is disclosed, the method comprising the steps of: capturing, by the mobile device, ambient audio signals having a frequency range between 20 and 7,000 hertz, wherein the ambient audio signals comprise background noise stemming from the location of the mobile device and a first audio signal generated by a first ultrasonic frequency transmitter; obtaining an audio fingerprint of the captured ambient audio signals; and communicating the obtained audio fingerprint to a database such that upon receiving the audio fingerprint, the database identifies the location of the mobile device using the obtained audio fingerprint and audio fingerprints stored in the database, whereby each audio fingerprint in the database is associated with a unique location.

With reference to the first aspect, in accordance with embodiments of the invention, the first audio signal generated by the ultrasonic frequency transmitter comprises intermodulation products of ultrasonic frequency signals transmitted by the first ultrasonic frequency transmitter.

With reference to the first aspect, in accordance with embodiments of the invention, the first audio signal generated by the ultrasonic frequency transmitter comprises subharmonic signals that are by-products of ultrasonic frequency signals transmitted by the first ultrasonic frequency transmitter.

With reference to the first aspect, in accordance with embodiments of the invention, the subharmonic signals comprise arithmetic divisions of the fundamental frequencies of the transmitted ultrasonic frequency signals.

With reference to the first aspect, in accordance with embodiments of the invention, the obtaining the audio fingerprint of the captured ambient audio signal comprises: determining from the ambient audio signal peaks and valleys occurring in the background noise and peaks and valleys occurring in the first audio signal; and associating a pattern obtained from the determined peaks and valleys as the audio fingerprint of the captured ambient audio signal.

With reference to the first aspect, in accordance with embodiments of the invention, step of the database determining the location of the mobile device using the obtained audio fingerprint and audio fingerprints stored in the database comprises: determining, using a distance matrix or weight matrix algorithm, if the obtained audio fingerprint matches an audio fingerprint stored in the database; and pinpointing the location of the mobile device as the unique location associated with the matched audio fingerprint stored in the database when it is determined that the obtained audio fingerprint matches with an audio fingerprint stored in the database.

With reference to the first aspect, in accordance with embodiments of the invention, the ambient audio signal further comprises a second audio signal generated by a second ultrasonic frequency transmitter provided a distance away from the first ultrasonic frequency transmitter, whereby the second ultrasonic frequency transmitter is configured to transmit ultrasonic frequency signals that constructively interfere with the ultrasonic frequency signals transmitted by the first ultrasonic frequency transmitter.

With reference to the first aspect, in accordance with embodiments of the invention, the method further comprises: capturing an image of a label; and transmitting the captured image to the database such that upon receiving the captured image, the database determines if the captured image corresponds to an unique image associated with the determined location of the mobile device.

With reference to the first aspect, in accordance with embodiments of the invention, the method further comprises: tagging a label; and transmitting the tagged label to the database such that upon receiving the tagged label, the database determines if the tagged label corresponds to an unique label associated with the determined location of the mobile device.

With reference to the first aspect, in accordance with embodiments of the invention, the tagging the label comprises: obtaining data from the label using near field communication or Bluetooth communication protocols.

According to a second aspect of the invention, a database configured to identify a location of a mobile device is disclosed, the database comprising: a processing unit; and a non-transitory media readable by the processing unit, the media storing instructions that when executed by the processing unit, cause the processing unit to: instruct the mobile device to: capture ambient audio signals having a frequency range between 20 and 7,000 hertz, wherein the ambient audio signals comprise background noise stemming from the location of the mobile device and a first audio signal generated by a first ultrasonic frequency transmitter; obtain an audio fingerprint of the captured ambient audio signals and communicate the obtained audio fingerprint to the database; receive the audio fingerprint and identify the location of the mobile device using the obtained audio fingerprint and audio fingerprints stored in the database, whereby each audio fingerprint in the database is associated with a unique location.

With reference to the second aspect, in accordance with embodiments of the invention, the first audio signal generated by the ultrasonic frequency transmitter comprises intermodulation products of ultrasonic frequency signals transmitted by the first ultrasonic frequency transmitter.

With reference to the second aspect, in accordance with embodiments of the invention, the first audio signal generated by the ultrasonic frequency transmitter comprises subharmonic signals that are by-products of ultrasonic frequency signals transmitted by the first ultrasonic frequency transmitter.

With reference to the second aspect, in accordance with embodiments of the invention, the subharmonic signals comprise arithmetic divisions of the fundamental frequencies of the transmitted ultrasonic frequency signals.

With reference to the second aspect, in accordance with embodiments of the invention, the instructions to obtain the audio fingerprint of the captured ambient audio signal comprises instructions for directing the processing unit to: determine from the ambient audio signal peaks and valleys occurring in the background noise and peaks and valleys occurring in the first audio signal; and associate a pattern obtained from the determined peaks and valleys as the audio fingerprint of the captured ambient audio signal.

With reference to the second aspect, in accordance with embodiments of the invention, the instructions for directing the database to identify the location of the mobile device using the obtained audio fingerprint and audio fingerprints stored in the database comprises: instructions for directing the processing unit to: determine, using a distance matrix or weight matrix algorithm, if the obtained audio fingerprint matches an audio fingerprint stored in the database; and pinpoint the location of the mobile device as the unique location associated with the matched audio fingerprint stored in the database when it is determined that the obtained audio fingerprint matches with an audio fingerprint stored in the database.

With reference to the second aspect, in accordance with embodiments of the invention, the ambient audio signal further comprises a second audio signal generated by a second ultrasonic frequency transmitter provided a distance away from the first ultrasonic frequency transmitter, whereby the second ultrasonic frequency transmitter is configured to transmit ultrasonic frequency signals that constructively interfere with the ultrasonic frequency signals transmitted by the first ultrasonic frequency transmitter.

With reference to the second aspect, in accordance with embodiments of the invention, the database further comprises: instructions for instructing the mobile device to direct the processing unit to: capture an image of a label; and transmit the captured image to the database such that upon receiving the captured image, the database determines if the captured image corresponds to an unique image associated with the determined location of the mobile device.

With reference to the second aspect, in accordance with embodiments of the invention, the database further comprises: instructions for instructing the mobile device to direct the processing unit to: tag a label; and transmit the tagged label to the database such that upon receiving the tagged label, the database determines if the tagged label corresponds to an unique label associated with the determined location of the mobile device.

With reference to the second aspect, in accordance with embodiments of the invention, the instructions for instructing the mobile device to direct the processing unit to tag the label comprises: instructions for directing the processing unit to: obtain data from the label using near field communication or Bluetooth communication protocols.

### BRIEF DESCRIPTION OF THE DRAWINGS

The above advantages and features in accordance with this invention are described in the following detailed description and are shown in the following drawings:

FIG. 1 illustrating a mobile device in a room within a building whereby each room is provided with ultrasonic frequency transmitters in accordance with embodiments of the invention;

FIG. 2 illustrating a block diagram representative of components in an electronic device or module for implementing embodiments in accordance with embodiments of the invention;

FIG. 3 illustrating a graph showing received ambient audio signals over a frequency range where a first graph illustrates an example of an enclosed space's ambient noise, a second graph shows an audio signal generated by an ultrasonic frequency transmitter, and a third graph shows the outcome when the ambient noise combines with the generated audio signal;

FIG. 4 illustrating three graphs, each showing an example of a unique ambient audio signal as obtained from each enclosed space or room within a building;

FIG. 5 illustrating a flow diagram of a process for identifying a location of a mobile device in accordance with embodiments of the invention; and

FIG. 6 illustrating a flow diagram of a process for identifying the location of the mobile device using a database in accordance with embodiments of the invention.

### DETAILED DESCRIPTION

This invention relates to a system and method for determining a location of a mobile device within an enclosed space using audio localization techniques. In particular, the system and method is able to identify the room or enclosed area within which the mobile device is located regardless whether the room or enclosed area is within a single storey building or multi-storey building. To achieve this, the system and method utilizes audio localization techniques to identify the location of mobile devices whereby ultrasonic frequency audio signals generated at each room are beyond the audible range of frequencies for most individuals and the ambient audio signals at each room are detected and processed using the mobile devices themselves.

One skilled in the art will recognize that many functional units in this description have been labelled as modules throughout the specification. The person skilled in the art will also recognize that a module may be implemented as circuits, logic chips or any sort of discrete component. Further, one skilled in the art will also recognize that a module may be implemented in software which may then be executed by a variety of processors. In embodiments of the invention, a module may also comprise computer instructions or executable code that may instruct a computer processor to carry out a sequence of events based on instructions received. The choice of the implementation of the modules is left as a design choice to a person skilled in the art and does not limit the scope of this invention in any way.

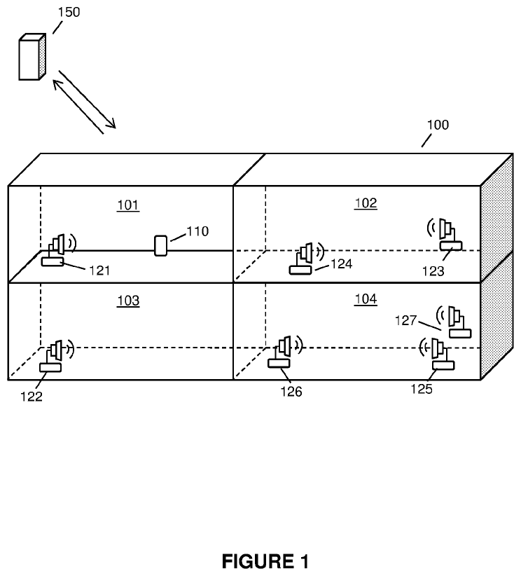

FIG. 1 illustrates mobile device 110 being provided at a specific location within building 100 which comprise multiple enclosed areas, e.g. rooms, and multiple levels. In FIG. 1, building 100 is shown to have four rooms, i.e. rooms 101, 102, 103 and 104, which are located at two levels. Provided within each room is at least one ultrasonic frequency transmitter whereby each ultrasonic frequency transmitter is configured to transmit audio signals in the ultrasonic frequency range. Audio signals transmitted in the ultrasonic frequency range comprise audio signals having a transmitted frequency between 20 kilohertz up to several kilohertz, e.g. 40 kHz, and signals within this frequency range are usually beyond the audible hearing range of most people. As illustrated in FIG. 1, ultrasonic frequency transmitter 121 is provided within room 101, ultrasonic frequency transmitters 123, 124 are provided within room 102, ultrasonic frequency transmitter 122 is provided within room 103, and ultrasonic frequency transmitters 125, 126, 127 are provided within room 104. One skilled in the art will recognize that building 100 may comprise of any number of rooms or any number of levels, and that any number of ultrasonic frequency transmitters may be provided within each room in building 100 without departing from this invention.

One skilled in the art will recognize that mobile device 110 may comprise of any mobile device that is configured with an audio receiver for detecting and capturing audio signals such as, but not limited, a smart phone, a tablet, a mobile computer, a laptop, or an handheld computing device.

FIG. 1 also illustrates database 150 which is located remote from building 100. Database 150 may comprise a secure server and/or a secure cloud server that is configured to wirelessly receive data from and transmit data to mobile device 110 and ultrasonic frequency transmitters 121-127. The wireless transmission of data between database 150 and mobile device 110 and transmitters 121-127 may take place using conventional mobile networks, Wireless Fidelity (Wi-Fi) networks or wireless local area networks.

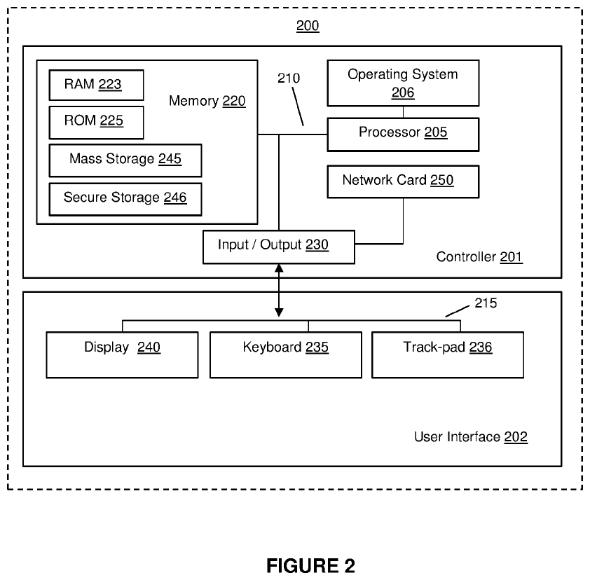

FIG. 2 illustrates a block diagram representative of components of an electronic module 200 that is provided within database 150, mobile device 110 or electronic modules that may be attached to each of the ultrasonic frequency transmitters for implementing embodiments in accordance with embodiments of the invention. One skilled in the art will recognize that the exact configuration of each electronic device provided within each module or controller may be different and the exact configuration of electronic module 200 may vary and that the layout and configuration of FIG. 2 is provided by way of example only.

In embodiments of the invention, module 200 comprises controller 201 and optionally user interface 202. If user interface 202 is provided, user interface 202 is arranged to enable manual interactions between a user and electronic device 200 and for this purpose includes the input/output components required for the user to enter instructions to control electronic module 200. A person skilled in the art will recognize that components of user interface 202 may vary from embodiment to embodiment but will typically include one or more of display 240, keyboard 235 and/or track-pad/touch-pad 236.

Controller 201 is in data communication with user interface 202 via bus 215 and includes memory 220, Central Processor (CPU) 205 mounted on a circuit board that processes instructions and data for performing the method of this embodiment, an operating system 206, an input/output (I/O) interface 230 for communicating with user interface 202 and a communications interface, in this embodiment in the form of a network card 250. Network card 250 may, for example, be utilized to send data from electronic device 200 via a wired or wireless network to other processing devices or to receive data via the wired or wireless network. Wireless networks that may be utilized by network card 250 include, but are not limited to, Wireless-Fidelity (Wi-Fi), Bluetooth, Near Field Communication (NFC), cellular networks, satellite networks, telecommunication networks, Wide Area Networks (WAN) and etc.

Memory 220 and operating system 206 are in data communication with CPU 205 via bus 210. The memory components include both volatile and non-volatile memory and more than one of each type of memory, including Random Access Memory (RAM) 220, Read Only Memory (ROM) 225 and a mass storage device 245, the last comprising one or more solid-state drives (SSDs). Memory 220 also includes secure storage 246 for securely storing private cryptographic keys such as root keys and/or private keys. It should be noted that the contents within secure storage 246 are only accessible by a super-user or administrator of module 200 and may not be accessed by any simple user of module 200. One skilled in the art will recognize that the memory components described above comprise non-transitory computer-readable media and shall be taken to comprise all computer-readable media except for a transitory, propagating signal. Typically, the instructions are stored as program code in the memory components but can also be hardwired. Memory 220 may include a kernel and/or programming modules such as a software application that may be stored in either volatile or non-volatile memory.

It should be noted that the term “CPU” is used to refer generically to any device or component that can process such instructions and may include: a microprocessor, microcontroller, programmable logic device or other computational device. That is, CPU 205 may be provided by any suitable logic circuitry for receiving inputs, processing them in accordance with instructions stored in memory and generating outputs (for example to the memory components or on display 240). In this embodiment, CPU 205 may be a single core or multi-core processor with memory addressable space. In one example, CPU 205 may be multi-core, comprising—for example—an 8 core CPU.

Before the system and method in accordance with embodiments of the invention may be used to identify the location of mobile device 110 within building 100, a unique ambient audio signal associated with each one of rooms 101-104 has to be captured and stored within database 150.

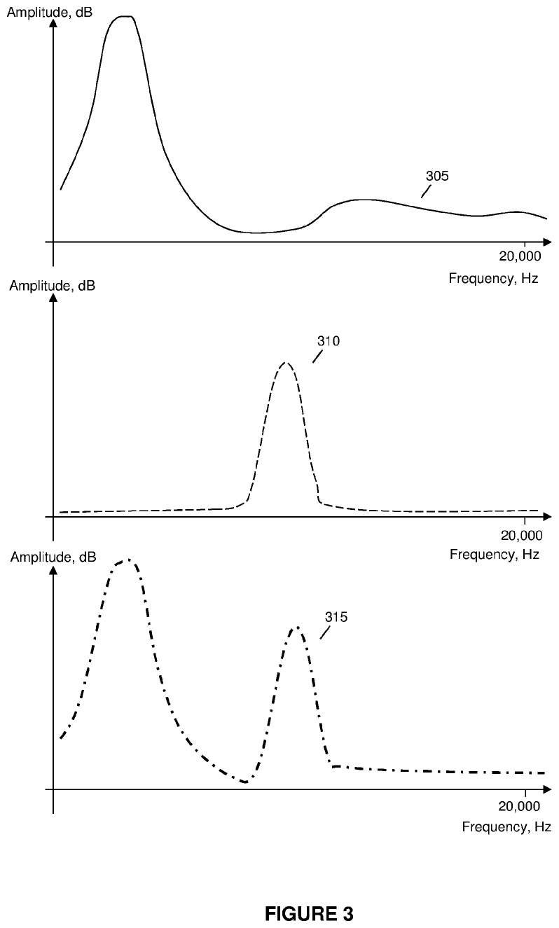

It is useful to note that each and every room in a building would have its own unique background noise or ambient noise. The source of the background noise in each room may be from noise sources such as, but not limited to, a fan or an air conditioner in the room, the humming of the room's lights or the whirring of the desktop computers' CPU fans in the room. Noise sources such as these would be treated as stable noise sources as these noise sources would consistently produce the same background noise throughout the day whereas unstable noise sources are treated as noises that occur sporadically, such as when people are talking in the room or when a radio is playing. For example, a room having a few computer servers and the air conditioner on would produce a background noise pattern that is different from the background noise pattern in another room which only has a ceiling fan emitting a whirring sound. Further, these noise sources would be treated as stable noise sources. An exemplary background noise of a room is plotted as plot 305 in FIG. 3. Plot 305 includes a single peak at the lower range of the frequency axis and this indicates that within the room, there is a noise source that is producing a substantial amount of low frequency noise. In embodiments of the invention, for practical reasons, a room's ambient or background noise would typically be within the range 20-7,000 hertz. This is because noises higher than 7,000 hertz would generate a pitch that will annoy most people within the room and as such, such noise sources would be switched off or dampened immediately.

The background noise in any room may be captured using an audio receiver such as a mobile phone's microphone. It is preferable to use an audio receiver that has the same sensitivity levels as the audio receiver in mobile device 110. This is to ensure that a similar ambient noise pattern may be reliably captured each time. It is useful to note at this point that mobile device 110 is provided with a standard microphone that is configured to capture audio signals within the audible range; that is a frequency range between 0-20,000 hertz. Hence, the microphone of mobile device 110 should be able to capture a range of background noise in most rooms as long as the background noise is within the microphone's sensitivity range of 0-20,000 hertz. In embodiments of the invention, the microphone's range may be limited to between 0-7,000 hertz.

It is understood that each room would have an ambient noise pattern. However, there is the strong likelihood that a room's ambient noise pattern may be almost similar to the ambient noise pattern in another room, especially if both rooms are provided with similar types of equipment. The rooms' noise patterns would only be different if the equipment in these rooms is completely different. For example, if rooms 101 and 102 both have air conditioners that are switched on; it is highly likely that the background noise patterns in rooms 101 and 102 would be same. This is because the source of the noise in both rooms is the air conditioner.

In such a situation, in order to differentiate room 101's background noise from room 102's background noise, an additional audio signal has to be broadcasted in either one of the rooms. This additional audio signal may be broadcasted using a standard audio transmitter such as a radio or the music player on mobile device 110. However, this is not ideal as the broadcast of music or such sounds would distract people in the vicinity of the room.

In order to address this problem, in accordance with embodiments of the invention, additional audio signals are broadcasted in the ultrasonic frequency range instead, which is 20,000 hertz and higher, within each room. As most people's audible hearing ranges are between 20-20,000 hertz, most people would not be able to hear the additional audio signals that are being transmitted by the ultrasonic frequency transmitters in each room. The limitation faced by this approach is that the microphone in mobile device 110 would not be able to capture audio signals that have a frequency upwards of 20,000 hertz because the microphone is designed to only capture audio signals in the audible range. Typically, most mobile devices carried by most users would also have this limitation.

In accordance with embodiments of this invention, the ultrasonic frequency transmitters are designed to be non-linear and are also configured to generate and transmit at least two signals. It is useful to understand that when signals are amplified using a non-linear system, intermodulation distortion will occur. This intermodulation distortion causes the occurrence of additional signals at other frequencies, in particular at the sum and difference frequencies of the original frequencies and at multiples of those sum and difference frequencies. A person skilled in the art will understand that intermodulation distortion occurs due to the amplitude modulation of two signals, when each signal has its own frequency. As a result, this produces additional signals at the sum and difference frequencies of these two signals and also at multiples of those sum and difference frequencies. Of particular interest to this invention are the difference frequencies of the original frequencies and their multiples.

Hence, when the ultrasonic frequency transmitters generate audio signals at the ultrasonic frequency range, intermodulation products originating from these audio signals would appear within mobile device 110's microphone range due to the difference frequencies of the original frequencies and their multiples. For example, under the assumption that transmitter 121 is non-linear and is configured to transmit a first audio signal having a fundamental frequency, f₁, of 23,000 hertz and a second audio signal having a fundamental frequency, f₂, of 21,000 hertz, this would result in the generation of a lower frequency second-order distortion product/or a beat tone and a third-order intermodulation product that may be detected by the microphone of mobile device 110, i.e. audio signals occurring at 2,000 hertz (f₁−f₂) and 19,000 hertz (2f₂−f₁). Although this example only illustrates the second and third order intermodulation products, one skilled in the art will recognize that other orders of intermodulation products will occur and other lower frequency beats or harmonics may be detected if they fall within the range of the microphone.

An exemplary plot of the lower frequency intermodulation products caused by the intermodulation of audio signals having fundamental frequencies in the ultrasonic frequency range is plotted as plot 310 in FIG. 3. Plot 310 shows a peak at the mid-range of the frequency axis and this is caused by the accumulation of intermodulation products of the transmitted ultrasonic audio signals by the non-linear ultrasonic frequency transmitters. The height and position of this peak may be adjusted by adjusting the signal strength and fundamental frequencies of the transmitted audio signals in the ultrasonic range.

With reference to room 101 in FIG. 1, this means that when transmitter 121 is configured as a non-linear transmitter that transmits audio signals having ultrasonic fundamental frequencies, the intermodulation products of these audio signals would appear within a frequency range detectable by mobile device 110.

Hence, ultrasonic frequency transmitters are provided within each room and are configured to transmit audio signals at ultrasonic frequencies to generate intermodulation products at the lower frequency range. The intermodulation products generated by these ultrasonic audio signals then combine with each room's background noise to produce a unique ambient audio signal for each room. For example, when plot 305 is combined with plot 310, this produces plot 315 which is a combination of the background noise pattern and the intermodulation products of ultrasonic audio signals. In this example, if plot 315 is associated with room 101, each time a pattern similar to plot 315 is captured by mobile device 110, the system's administrator would understand that mobile device 110 is located within room 101.

Based on this concept, transmitters in each room are then configured to transmit audio signals that will produce intermodulation products in a lower frequency range that may then combine with each room's background noise to produce unique ambient audio signals for each room.

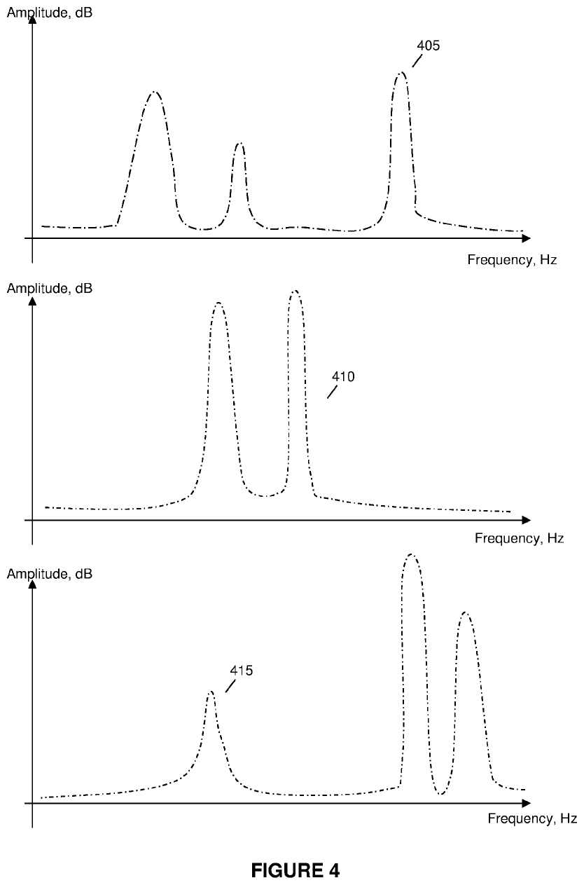

FIG. 4 illustrates exemplary ambient audio signals that may be generated for each of rooms 102, 103 and 104. Plot 405 may be a combination of room 102's background noise and the lower frequency intermodulation products of ultrasonic audio signals produced by transmitters 123 and 124, plot 410 may be a combination of room 103's background noise and the lower frequency intermodulation products of ultrasonic audio signals produced by transmitter 122 and plot 415 may be a combination of room 104's background noise and the lower frequency intermodulation products of ultrasonic audio signals produced by transmitters 125, 126 and 127.

The plots or patterns of ambient audio signals of each room are then stored in database 150 whereby each plot stored in database 150 is associated with its own room. For the example above, this means that if mobile device 110 were to capture an ambient audio signal in a room that has a pattern or plot similar to plot 410, this would mean that mobile device 110 is located within room 103.

As can be seen from FIG. 1, room 102 is provided with two transmitters, transmitters 123 and 124 while room 104 is provided with three transmitters, transmitters 125, 126 and 127. In these rooms that have more than one transmitter, after the transmitters have been set in their respective locations in the room, each of these transmitters are then configured to transmit ultrasonic audio signals that constructively interfere with other ultrasonic audio signals that are being transmitted by transmitters in the room. This is to ensure that the transmitted signals do not cancel each other out and this also reduces the power consumption of each individual transmitter as these transmitters do not need to worry about the effect of destructive interference from the other transmitters.

Hence, before the location of mobile device 110 may be identified within building 100, unique ambient audio signals have to be generated for each room in building 100. This is accomplished using transmitters located within each room whereby the transmitters are configured to generate ultrasonic audio signals having intermodulation products that will combine with each room's background noise. As mentioned earlier, each room's background noise will typically be between the range 20-7,000 hertz as such, the audio range captured for each room may be limited to this range as well. Ambient audio signals associated with each room are then captured and stored in database 150. The capturing and transmission of each room's ambient audio signal may be done a device having similar characteristics as that of mobile device 110.

In accordance with embodiments of the invention, when the system is implemented, mobile device 110 will use an audio capturing device in mobile device 110, e.g. a microphone, to capture the ambient audio signal of the room it is in, e.g. room 101. As the microphone has audio sensitivity between 20-20,000 hertz, this means that mobile device 110 will capture all audio plots within this range. In embodiments of the invention, the microphone is configured to capture audio plots between 20-7,000 hertz as it is unlikely that audio signals above 7,000 hertz would be present in the room as audio signals above 7,000 hertz would annoy most people in its vicinity. In embodiments of the invention, mobile device 110 may be configured to periodically capture the ambient audio signal of the room or alternatively, mobile device 110 may be configured to capture the ambient audio signal of the room upon receipt of instructions from database 150. Regardless of the method adopted, the captured ambient audio signal is then be transmitted to database 150 for further processing or if the captured data may not be transmitted immediately, the data may be first stored within mobile device 110 and subsequently transmitted when device 110 establishes communication channels with database 150 either wirelessly or through wired means.

In accordance with other embodiments of the invention, once mobile device 110 has captured the ambient audio signal of the room, mobile device 110 may be configured to compute the audio fingerprint of the captured ambient audio signal. This may be done using the feature extraction method, distance matrix evaluation techniques, and/or weight matrix techniques. The peaks and valleys occurring in the captured ambient audio signal (i.e. peaks and valleys occurring in the background noise and peaks and valleys occurring in the intermodulation products of the ultrasonic audio signals) may also be utilized to establish an audio fingerprint for the captured ambient audio signal. One skilled in the art will recognize that other fingerprinting methods or techniques may be employed without departing from the invention provided that these methods are able to accurately categorize the captured ambient audio signal into a unique pattern or record that may be used to match with the data stored in database 150. In this embodiment, a similar fingerprinting method has to be applied to the ambient audio signals stored in database 150. This is to ensure that when audio fingerprints are transmitted from mobile device 110, the audio fingerprints received by database 150 may be matched with existing audio fingerprints stored in database 150's records.

When database 150 receives the captured ambient audio signal from mobile device 110, database 150 will attempt to match the captured ambient audio signal with an existing pattern stored within its records. If database 150 is able to find a match, database 150 then determines the location of mobile device 110 based on the location associated with the matched ambient audio signal. Based on the previous example, this means that if database 150 receives an ambient audio signal that matches with plot 415 in its records, database 150 would then determine that mobile device 110 is located at room 104.

In other embodiments of the invention, as an additional verification step, rooms in building 100 may be randomly provided with labels. These labels may comprise of, but are not limited to, bar-codes, matrix or two-dimensional codes, pictures or any sort of image that may be used to uniquely identify a room. These labels may also comprise Bluetooth tags, RFID tags, or any other form of near field communication (NFC) tags that may be used to exchange data between the label and mobile device 110. During the initial step of setting up the mobile device identification system of this invention, as each room's ambient noise signal is being captured and added to database 150's records, the labels in each room would also be simultaneously captured and stored in database 150. This may be done using an image capturing device such as a camera or if the label is NFC enabled, a corresponding NFC module in the mobile device may be used. Based on the previous example, this means that if room 101 is provided with such a label, this label would be captured and stored in database 150 when room 101's ambient noise signal is being captured and recorded into database 150.

Hence, when a user of mobile device 110 is in room 101, in addition to capturing the ambient audio signal in room 101, the user will also be required to capture the label in the room. One skilled in the art will recognize that references to “capturing” the label may refer to utilizing NFC means or image capturing means for obtaining data associated with the label. The captured ambient audio signal and the captured label are then sent to database 150 to be processed as previously described. This means that the data associated with the captured label will also be matched with a label associated with the identified room to verify that the correct room has been identified. This two-factor authentication step ensures that rooms in building 100 may be accurately identified and verified.

In other embodiments of the invention, in rooms that are configured to have two or more transmitters, such as room 102 that is provided with two transmitters, transmitters 123 and 124 and room 104 that is provided with three transmitters, transmitters 125, 126 and 127, these transmitters may be utilized to determine an approximate location of mobile device 110 within each one of these rooms. This is best explained using room 102 and transmitters 123 and 124 that are provided within this room. It is assumed that transmitter 123 is provided at a first end of room 102 while transmitter 124 is provided at an opposing end of room 102.

In operation, mobile device 110 will capture the ambient audio signal in the room. If mobile device 110 is located nearer to transmitter 124, the peak in the ambient audio signal contributed by signals from transmitter 124 will be higher while the peak in the ambient signal contributed by signals from transmitter 123 will be lower. This shows that mobile device 110 is located nearer to transmitter 124 and further away from transmitter 123. Conversely, if mobile device 110 is located nearer to transmitter 123, the peak in the ambient audio signal contributed by signals from transmitter 123 will be higher while the peak in the ambient signal contributed by signals from transmitter 124 will be lower.

During the initial setup stage, if various zones within room 102 are mapped out using the technique described above, once database 150 receives the captured ambient audio signal from mobile device 110, database 150 will be able to identify the zone in the room in which mobile device 110 is located within. This means that if more transmitters are provided within a room, the location of the mobile device within the room may be more accurately identified.

In accordance with embodiments of this invention, the ultrasonic frequency transmitters may instead be designed to generate subharmonic signals whereby these subharmonic signals are a by-product of ultrasonic frequency signals transmitted by these transmitters. To ensure that the by-product of the ultrasonic frequency signals includes subharmonic signals, the transmitters are configured as sine wave generators. Each generator is then configured to have a speaker cone that is in physical contact with a supple and resilient surface. When the transmitters are transmitting ultrasonic signals, these transmitted signals will then cause the resilient surface to oscillate at periodic intervals which in turn produces a series of subharmonic signals that appear at arithmetic divisions of the fundamental transmitted frequency, e.g. (½*f, ⅓*f, ¼*f, ⅕*f . . . ) where f is the fundamental frequency.

Hence, in this embodiment of the invention, when the ultrasonic frequency transmitters generate audio signals at the ultrasonic frequency range, subharmonic signals originating from these audio signals would appear within mobile device 110's microphone range.

With reference to room 101 in FIG. 1, this means that when transmitter 121 is configured to generate by-product signals that include subharmonic signals, the by-products of these audio signals would appear within a frequency range detectable by mobile device 110. The subharmonic signals generated by these ultrasonic audio signals then combine with each room's background noise to produce a unique ambient audio signal for each room. These ultrasonic frequency transmitters may then be applied to the system as described above to carry out embodiments of the invention.

In still yet a further embodiment of the invention, ultrasonic transmitters in a room may comprise of an ultrasonic transmitter that is configured to generate ultrasonic signals having subharmonic signals as by-products and an ultrasonic transmitter that is configured to generate intermodulation products. In other words, these two types of transmitters may be used interchangeably or combined as required in accordance with embodiments of the invention. The main objective of these two types of transmitters is to produce as by-products of ultrasonic frequency signals, lower frequency signals that may be detected and captured by a mobile device's microphone.

In accordance with embodiments of the invention, a method for identifying a location of a mobile device comprises the following steps:
Step 1, capturing, by the mobile device, an ambient audio signal having a frequency range between 20 and 7,000 Hz, wherein the ambient audio signal comprises background noise stemming from the location of the mobile device and a first audio signal generated by a first ultrasonic frequency transmitter;
Step 2, obtaining an audio fingerprint of the captured ambient audio signal,
Step, communicating the obtained audio fingerprint to a database such that upon receiving the audio fingerprint, the database identifies the location of the mobile device using the obtained audio fingerprint and audio fingerprints stored in the database, whereby each audio fingerprint in the database is associated with a unique location.

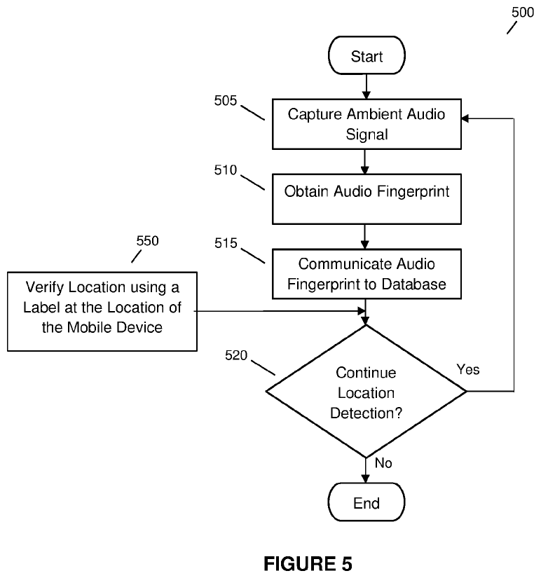

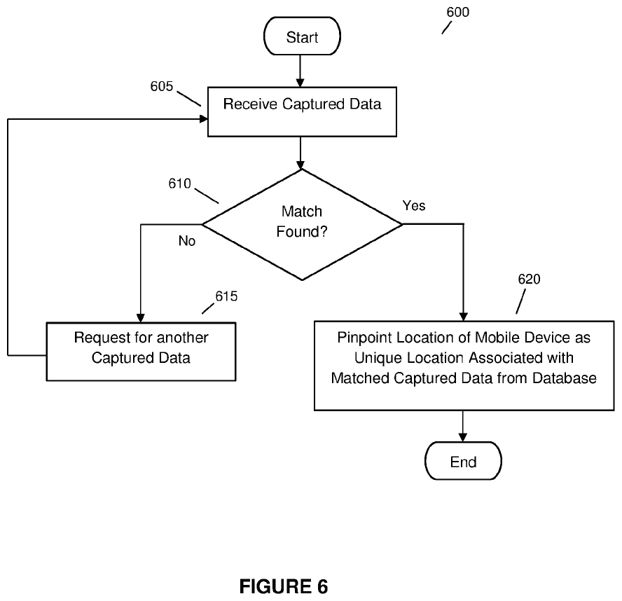

In order to provide such a method, a process is needed for configuring the device to reinforce the control flow integrity of a software application. The following description and FIGS. 5 and 6 describe embodiments of processes that provide the necessary steps in accordance with this invention.

FIG. 5 illustrates process 500 that is performed by a mobile device to identify its location to a database in accordance with embodiments of the invention. Process 500 begins at step 505 by capturing ambient audio signals in the vicinity of the mobile device. This ambient audio signal is in the range between 20 and 20,000 hertz, or ideally between 20 and 7,000 hertz, as this is the frequency range detectable by the mobile device's microphone. This ambient audio signal is made up of the room's background noise and an audio signal generated by an ultrasonic frequency transmitter provided in the room.

Process 500 then determines a pattern associated with in the captured ambient audio signals at step 510. This may be done by process 500 obtaining an audio fingerprint for the captured ambient audio signals. The audio fingerprint is then transmitted to a remote database at step 515.

At step 520, process 500 then determines whether the mobile device should continue the process of identifying its location to the remote database. If it is determined that the process should continue, process 500 proceeds to step 505 and steps 505-520 repeats itself until process 500 ends.

In embodiments of the invention, in between steps 515 and 520, an additional step of verifying the location of the mobile device may be carried out by process 500. This occurs at step 550 whereby the location of the mobile device is further verified by having process 500 capture data of a label that is provided at the location of the mobile device. Data captured from the label is then transmitted by process 500 to the remote database. The database then utilizes this data to further verify the location of the mobile device.

FIG. 6 illustrates process 600 that is performed by a database to identify the location of the mobile device based on the captured data transmitted by the mobile device to the database in accordance with embodiments of the invention. The captured data received by the database may include ambient audio signals captured by the mobile device and/or data associated with a label as captured by the mobile device.

Process 600 begins at step 605 with process 600 receiving the captured data from the mobile device. Process 600 then attempts to match the captured data with data stored within the database's records. If process 600 is able to obtain a match, the location associated with the matched data from the database's records is then used to identify the location of the mobile device. This takes place at step 620. Conversely, if process 600 is unable to obtain a match, process 600 will proceed to step 615. At step 615, process 600 then requests for additional captured data from the mobile device. Process 600 then returns to step 605 whereby it receives the newly captured data from the mobile device. Process 600 then repeats itself until the location of the mobile device has been pinpointed by process 600. Process 600 then ends after step 620.

The above is a description of embodiments of a system and process in accordance with the present invention as set forth in the following claims. It is envisioned that others may and will design alternatives that fall within the scope of the following claims.

1. A method for identifying a location of a mobile device comprising:
capturing, by the mobile device, ambient audio signals having a frequency range between 20 and 7,000 hertz, wherein the ambient audio signals comprise background noise stemming from the location of the mobile device and a first audio signal generated by a first non-linear ultrasonic frequency transmitter;
obtaining an audio fingerprint of the captured ambient audio signals; and
communicating the obtained audio fingerprint to a database such that upon receiving the audio fingerprint, the database identifies the location of the mobile device using the obtained audio fingerprint and audio fingerprints stored in the database, whereby each audio fingerprint in the database is associated with a unique location.

2. The method according to claim 1 wherein the first audio signal generated by the first non-linear ultrasonic frequency transmitter comprises intermodulation products of ultrasonic frequency signals transmitted by the first non-linear ultrasonic frequency transmitter.

3. The method according to claim 1 wherein the first audio signal generated by the first non-linear ultrasonic frequency transmitter comprises subharmonic signals that are by-products of ultrasonic frequency signals transmitted by the first non-linear ultrasonic frequency transmitter.

4. The method according to claim 3 wherein the subharmonic signals comprise arithmetic divisions of the fundamental frequencies of the transmitted ultrasonic frequency signals.

5. The method according to claim 1 wherein the obtaining the audio fingerprint of the captured ambient audio signal comprises:
determining from the ambient audio signal peaks and valleys occurring in the background noise and peaks and valleys occurring in the first audio signal; and
associating a pattern obtained from the determined peaks and valleys as the audio fingerprint of the captured ambient audio signal.

6. The method according to claim 1 wherein the step of the database identifying the location of the mobile device using the obtained audio fingerprint and audio fingerprints stored in the database comprises:
determining if the obtained audio fingerprint matches an audio fingerprint stored in the database, whereby the obtained audio fingerprint is generated from the ambient audio signals using a distance matrix or weight matrix algorithm; and
pinpointing the location of the mobile device as the unique location associated with the matched audio fingerprint stored in the database when it is determined that the obtained audio fingerprint matches with an audio fingerprint stored in the database.

7. The method according to claim 1 wherein the ambient audio signal further comprises a second audio signal generated by a second non-linear ultrasonic frequency transmitter provided a distance away from the first non-linear ultrasonic frequency transmitter, whereby the second non-linear ultrasonic frequency transmitter is configured to transmit ultrasonic frequency signals that constructively interfere with the ultrasonic frequency signals transmitted by the first non-linear ultrasonic frequency transmitter.

8. The method according to claim 1 further comprising:
capturing an image of a label; and
transmitting the captured image to the database such that upon receiving the captured image, the database determines if the captured image corresponds to an unique image associated with the determined location of the mobile device.

9. The method according to claim 1 further comprising:
tagging a label; and
transmitting the tagged label to the database such that upon receiving the tagged label, the database determines if the tagged label corresponds to an unique label associated with the determined location of the mobile device.

10. The method according to claim 9 wherein the tagging the label comprises:
obtaining data from the label using near field communication or Bluetooth communication protocols.

11. A database configured to identify a location of a mobile device, the database comprising:
a processing unit; and
a non-transitory media readable by the processing unit, the media storing instructions that when executed by the processing unit, cause the processing unit to:
instruct the mobile device to:
capture ambient audio signals having a frequency range between 20 and 7,000 hertz, wherein the ambient audio signals comprise background noise stemming from the location of the mobile device and a first audio signal generated by a first non-linear ultrasonic frequency transmitter; and
obtain an audio fingerprint of the captured ambient audio signals and communicate the obtained audio fingerprint to the database;
receive the audio fingerprint and identify the location of the mobile device using the obtained audio fingerprint and audio fingerprints stored in the database, whereby each audio fingerprint in the database is associated with a unique location.

12. The database according to claim 11 wherein the first audio signal generated by the first non-linear ultrasonic frequency transmitter comprises intermodulation products of ultrasonic frequency signals transmitted by the first non-linear ultrasonic frequency transmitter.

13. The database according to claim 11 wherein the first audio signal generated by the first non-linear ultrasonic frequency transmitter comprises subharmonic signals that are by-products of ultrasonic frequency signals transmitted by the first non-linear ultrasonic frequency transmitter.

14. The database according to claim 13 wherein the subharmonic signals comprise arithmetic divisions of the fundamental frequencies of the transmitted ultrasonic frequency signals.

15. The database according to claim 11 wherein the instructions to obtain the audio fingerprint of the captured ambient audio signal comprises:
instructions for directing the processing unit to:
determine from the ambient audio signal peaks and valleys occurring in the background noise and peaks and valleys occurring in the first audio signal; and
associate a pattern obtained from the determined peaks and valleys as the audio fingerprint of the captured ambient audio signal.

16. The database according to claim 11 wherein the instructions for directing the database to identify the location of the mobile device using the obtained audio fingerprint and audio fingerprints stored in the database comprises:
instructions for directing the processing unit to:
determine if the obtained audio fingerprint matches an audio fingerprint stored in the database, whereby the obtained audio fingerprint is generated from the ambient audio signals using a distance matrix or weight matrix algorithm; and
pinpoint the location of the mobile device as the unique location associated with the matched audio fingerprint stored in the database when it is determined that the obtained audio fingerprint matches with an audio fingerprint stored in the database.

17. The database according to claim 11 wherein the ambient audio signal further comprises a second audio signal generated by a second non-linear ultrasonic frequency transmitter provided a distance away from the first non-linear ultrasonic frequency transmitter, whereby the second non-linear ultrasonic frequency transmitter is configured to transmit ultrasonic frequency signals that constructively interfere with the ultrasonic frequency signals transmitted by the first non-linear ultrasonic frequency transmitter.

18. The database according to claim 11 further comprising:
instructions for instructing the mobile device to direct the processing unit to:
capture an image of a label; and
transmit the captured image to the database such that upon receiving the captured image, the database determines if the captured image corresponds to an unique image associated with the determined location of the mobile device.

19. The database according to claim 11 further comprising:
instructions for instructing the mobile device to direct the processing unit to:
tag a label; and
transmit the tagged label to the database such that upon receiving the tagged label, the database determines if the tagged label corresponds to an unique label associated with the determined location of the mobile device.

20. The database according to claim 19 wherein the instructions for instructing the mobile device to direct the processing unit to tag the label comprises:
instructions for directing the processing unit to:
obtain data from the label using near field communication or Bluetooth communication protocols.
